(19) United States
(12) Patent Application Publication
(10) Pub. No.: US 2006/0125796 A1
(43) Pub. Date: Jun. 15, 2006

(54) Systems and methods for configuring user interface devices

(76) Inventors: James R. Utz, Round Rock, TX (US); Johnny C. Fraga, Round Rock, TX (US)

Correspondence Address: William W. Enders;O'KEEFE, EGAN & PETERMAN, Building C, Suite 200, 1101 Capital of Texas Highway South, Austin, TX, 78746, US

(21) Appl. No.: 11/009,283

(22) Filed: Dec. 10, 2004

(51) Int. Cl. G09G 5/00

(52) U.S. Cl. 345/168

(57) ABSTRACT

Systems and methods for positioning a keyboard of an information handling system such as a notebook computer relative to one or more other user interface devices of the information handling system, for example, to improve ergonomic alignment of the user interface devices of the information handling system.

### BACKGROUND OF THE INVENTION

1. Field of the Invention

This invention relates generally to configuration of user interface devices, and more particularly to configuration of keyboards for information handling systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Examples of portable information handling systems include notebook computers. These portable devices continue to evolve with changing technology and to address the needs of users. It is common for conventional notebook computers to have a standard pitch keyboard with a text home position (e.g., the center of the “B” key of a standard English QWERTY keyboard) that is shifted to the left of the vertical centerline of the notebook computer display in order to accommodate the size of the keyboard. For example, the text home position of a conventional notebook computer that does not have a numeric keypad is shifted about 14.39 mm to the left of the vertical centerline of the notebook computer display.

Notebook computers with wide-aspect ratio displays (e.g., 17 inch diagonal wide-aspect ratio displays) are increasing in popularity. Notebook computers are also increasing in overall size and palmrest surface area. Some notebook computer models are now wide enough to accommodate a standard pitch keyboard that includes a text keypad segment and an embedded numeric keypad segment within the width of the product. However, to accommodate both the text keypad segment and the embedded numeric keypad segment in the available keyboard area of conventional notebook computer models requires shifting the text home position of text keypad segment and associated touchpad further to the left relative to the vertical centerline of the display. In this regard, conventional notebook computers typically require an additional leftward offset of about 38 mm or two full key widths for the general placement of a keyboard that includes both text keypad and numeric keypad segments relative to the center of the display. This represents a total leftward shift of the keyboard text home position by about 52.39 mm or about 2 inches relative to the center of the display.

FIG. 1 shows an overhead view of a conventional notebook computer 100 in fully unfolded or open condition about hinge line 120. Notebook computer 100 has a display 108, touchpad 112, touchpad buttons 111, stick pointer 107, stick pointer buttons 113 and a keyboard 101 that includes a English QWERTY text keypad segment 102 and an embedded numeric keypad segment 103 that are indicated in dashed outline in FIG. 1. The text keypad segment 102 and numeric keypad segment together substantially span the width of notebook computer 100. As illustrated in FIG. 1, there is a leftward offset 110 of about 2 inches between a vertical extension line 104 of the text home position of text keypad segment 102 and the vertical centerline 106 of display 108. Leftward offset 110 causes the user interface components (display 108, keyboard 102 and touchpad 112) of notebook computer 100 to be non-ergonomically aligned. A similar problem exists with other keyboard configurations, such as those employing German QWERTZ text keypad segments and French AZERTY text keypad segments.

### SUMMARY OF THE INVENTION

Disclosed herein are systems and methods for configuring user interface devices of an information handling system and, in particular, for positioning a keyboard of an information handling system relative to one or more other user interface devices of the information handling system. The disclosed systems and methods may be advantageously configured to provide a keyboard that is capable of moving or translating between two or more different positions relative to the position of one or more other user interface devices associated with the information handling system, for example, to more closely align or to substantially align the keyboard with one or more other user interface devices of the information handling system. Among other things, the disclosed systems and methods may be advantageously implemented to improve ergonomic alignment of multiple user interface devices of an information handling system.

In one embodiment, a portable information handling system, such as notebook computer, may be configured with a movable or translating keyboard that is capable of moving or translating between two or more positions that are different relative to the position of other user interface devices (e.g., such as a display monitor, touchpad, etc.) of the portable information handling system. For example, a keyboard of a portable information handling system may be configured to move manually or automatically from a first stowed position in which the text home position of the keyboard (e.g., centerline between home bar keys, such as vertical centerline between home bar keys F and J of the home row keys of a standard English QWERTY keypad segment, a position that also corresponds to the center of the “B” key) is located at a first distance from the vertical centerline of a display attached to the portable information handling system, to a second deployed position in which the text home position of the keyboard is located at a second distance that is closer to the vertical centerline of the attached display of the portable information handling system than the first distance. The keyboard may be further configured to return manually or automatically from the second deployed position to the first stowed position, e.g., for purposes of transporting the portable information handling system. In one exemplary embodiment, the text home position of the keyboard may be substantially aligned in the second deployed position with the vertical centerline of the display of the portable information handling system to provide substantially ergonomic alignment of the keyboard with the display, meaning that the center of the text home position is vertically aligned with the center of the display screen and, where stick pointer interface and touchpad are present, that the center of the text home position and the center of the stick pointer interface are vertically aligned with the center of the touchpad and the center of the display screen. Such ergonomic alignment encourages left-to-right alignment of a user's hands, arms, back and head while the user interacts with the portable information handling system.

The disclosed systems and methods may be advantageously implemented in one embodiment to provide a movable and alignable keyboard (e.g., including a text keypad segment with or without an associated numeric keypad segment) for use in an area of insufficient size to allow a fixed keyboard to be substantially aligned for use with one or more other user interface devices of an information handling system. In one exemplary embodiment, this capability may be advantageously implemented to provide a portable information handling system with a full standard pitch movable keyboard that includes a text keypad segment and numeric keypad segment that together substantially span the horizontal width of the portable information handling system. In such an embodiment, the movable keyboard may be stowed in first position entirely contained within the horizontal and vertical boundaries of the base assembly of the portable information handling system, and in which the text home position of the keyboard is not aligned with at least one other interface device of the portable information handling system. The movable keyboard may be deployed to a second position in which a right side portion of the keyboard lies outside the right horizontal boundary of the base assembly of the portable information handling system device, and so that the text home position of the keyboard is now substantially aligned with the at least one other interface device of the portable information handling system.

Such a movable and alignable keyboard configuration may be employed, for example, as an alternative to conventional notebook computer configurations that utilize a fixed keyboard having a text home position that is not aligned with the display and touchpad interface devices of the computer. In this regard, the movable and alignable keyboard may be placed in the second position to allow the text home position of the keyboard to be substantially aligned with the notebook display, and then may be placed in the first position to stow the keyboard so that the notebook computer has the same overall dimensions as a conventional notebook computer for transportation purposes.

In one respect, disclosed herein is a method for configuring a portable information handling system (e.g., such as notebook computer) that includes centrally mounting a touchpad in the palmrest so that the center of the touchpad is aligned with the center of the display screen of the portable information handling system in a fixed location. The method also includes mounting a keyboard on a moveable plate or tray in the palmrest of the base housing assembly of the portable information handling system so that upon opening a lid of the portable information handling system the movable keyboard assembly that includes the keyboard and plate slides rightwards with enough motion so as to align itself to the touchpad and display screen, thus centering the entire user interface (e.g., touchpad, pointer stick, keyboard and display screen). The movable keyboard assembly may be configured to be slid manually to the right, or so that it slides to the right with the assistance of a mechanism, e.g., spring and damper, small pneumatic plunger, electric motor, etc. Upon closing the portable information handling system, the movable keyboard assembly may be configured to be returned to its leftmost position (left offset position relative to the display screen), such that no part of the keyboard assembly extends beyond the right side of the base housing assembly of the portable information handling system.

In one respect, disclosed herein is an information handling system, including: a base assembly; a first user interface device fixedly coupled in a horizontal direction to the base assembly; and a movable keyboard assembly movably coupled to the base assembly so that the movable keyboard assembly is selectably movable in the horizontal direction between a first position relative to the first user interface device and a second position relative to the first user interface device, the movable keyboard being more closely vertically aligned with the first user interface device when the movable keyboard assembly is disposed in the second position than when disposed in the first position.

In another respect, disclosed herein is a notebook computer, including: a base assembly; a display device having a centerline and being coupled to the base assembly by one or more hinge mechanisms so that the display device is hingeably movable between an open position and a closed position relative to the base assembly; and a movable keyboard assembly movably coupled to the base assembly so that the movable keyboard assembly is selectably movable in a horizontal direction between a first stowed position relative to the display device and a second deployed position relative to the display device. The movable keyboard assembly may include a movable keyboard having a text keypad segment, the text keypad segment having a text home position, the text home position of the text keypad segment being more closely vertically aligned with the centerline of the display device when the movable keyboard assembly is disposed in the second position than when disposed in the first position.

In another respect, disclosed herein is a method for configuring an information handling system, including: providing a first user interface device coupled to a base assembly so that the first user interface device is horizontally fixed in position relative to the base assembly; and movably coupling a movable keyboard assembly to the base assembly so that the movable keyboard assembly is selectably and horizontally movable between a first position relative to the first user interface device and a second position relative to the first user interface device, the movable keyboard being more closely vertically aligned with the first user interface device when the movable keyboard assembly is disposed in the second position than when disposed in the first position.

### BRIEF DESCRIPTION OF THE DRAWINGS

FIG. 1 is an overhead view of a prior art notebook computer having a keyboard with an embedded numeric keypad.

FIG. 2 is an overhead view of a notebook computer having a movable keyboard in stowed position according to one embodiment of the disclosed systems and methods.

FIG. 3 is a right side view of the notebook computer of FIG. 2 according to one embodiment of the disclosed systems and methods.

FIG. 4A is an overhead view of the notebook computer of FIG. 2 with movable keyboard in deployed position according to one embodiment of the disclosed systems and methods.

FIG. 4B is an exploded perspective view of the notebook computer of FIGS. 2-4A according to one embodiment of the disclosed systems and methods.

FIG. 5 is an overhead view of a notebook computer having a movable keyboard in stowed position according to one embodiment of the disclosed systems and methods.

FIG. 6 is a right side view of the notebook computer of FIG. 5 according to one embodiment of the disclosed systems and methods.

FIG. 7 is an overhead view of the notebook computer of FIG. 5 with movable keyboard in deployed position according to one embodiment of the disclosed systems and methods.

FIG. 8 is an overhead view of a notebook computer having a movable keyboard in stowed position according to one embodiment of the disclosed systems and methods.

FIG. 9 is a right side view of the notebook computer of FIG. 8 according to one embodiment of the disclosed systems and methods.

FIG. 10 is an overhead view of the notebook computer of FIG. 8 with movable keyboard in deployed position according to one embodiment of the disclosed systems and methods.

FIG. 11 is a right side view of the notebook computer of FIG. 10 according to one embodiment of the disclosed systems and methods.

FIG. 12 is an overhead view of a base assembly of a notebook computer with movable keyboard in stowed position according to one embodiment of the disclosed systems and methods.

FIG. 13 is an overhead view of the notebook computer base assembly of FIG. 12 with movable keyboard in deployed position according to one embodiment of the disclosed systems and methods.

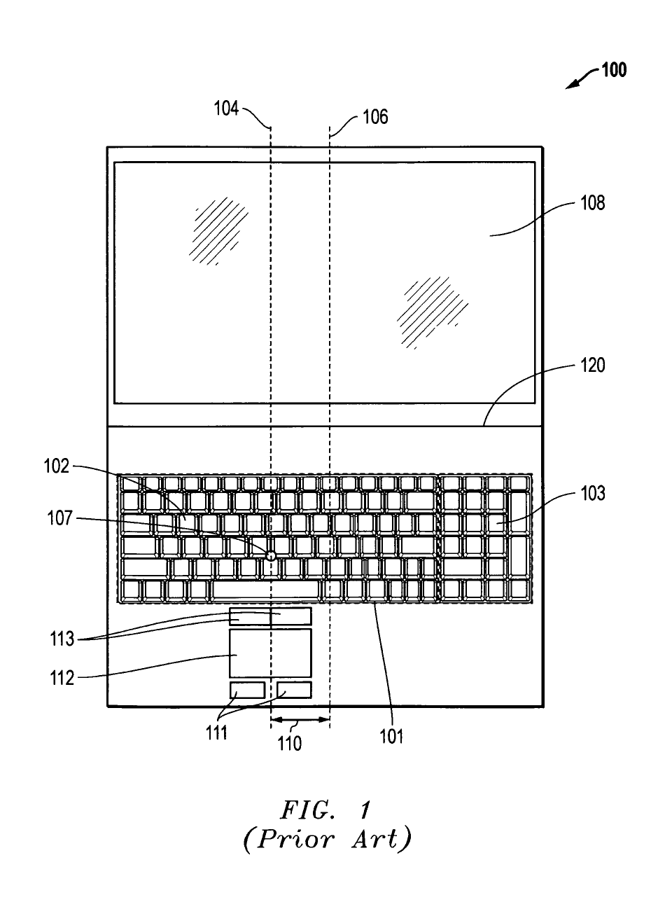

### DESCRIPTION OF ILLUSTRATIVE EMBODIMENTS

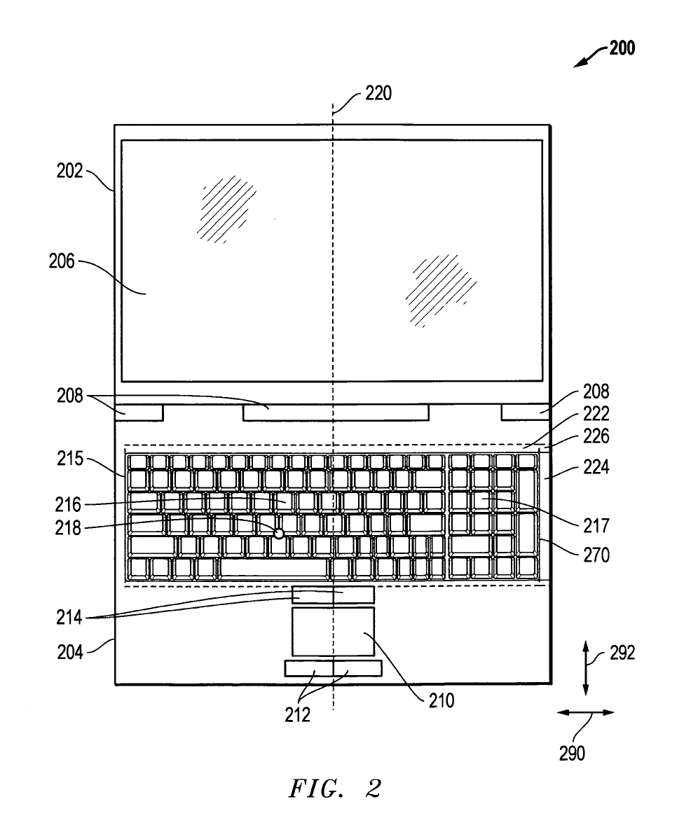

FIG. 2 is an overhead view of a portable information handling system that is configured in this exemplary embodiment as a notebook computer 200. As shown, notebook computer 200 includes a lid portion 202 that is attached to a base assembly 204 at a hinge line defined by hinge mechanisms 208. In FIG. 2, notebook computer 200 is shown with lid portion 202 in fully unfolded or open condition relative to base assembly 204 about a hinge line defined by hinge mechanisms 208. A display 206 (e.g., LCD or other suitable display device) is disposed within lid 202, and a movable keyboard 215 of a movable keyboard assembly 270 is shown disposed in stowed leftmost position within a palmrest area of base assembly 204, i.e., movable keyboard 215 is horizontally and vertically contained within base assembly 204 of notebook computer 200. As used herein, the term “horizontal” refers to a direction parallel to the longitudinal axis of movable keyboard 215 (i.e., as indicated by double-sided arrow 290 in FIG. 2) and the term “vertical” refers to a direction perpendicular to the longitudinal axis of movable keyboard 215 (i.e., as indicated by double-sided arrow 292 in FIG. 2). In the exemplary embodiment of FIG. 2, movable keyboard 215 is configured as a single piece keyboard assembly that includes an English QWERTY text keypad segment 216, a numeric keypad segment 217 and stick pointer 218 provided adjacent to text home position of movable keyboard 215 (i.e., the center of the “B” key that coincides with the vertical centerline between home bar keys F and J). A touchpad 210, touchpad buttons 212 and stick pointer buttons 214 are also shown provided on base assembly 204 adjacent to keyboard 215. In the illustrated embodiment of FIG. 2, the keys of text keypad segment 216 may be characterized as being positioned or laid-out in rows that are oriented in a horizontal direction (e.g., QWERTYUIOP, ASDFGHJKL, and ZXCVBNM keyboard rows of English QWERTY text keypad segment 216).

It will be understood that the illustrated movable keyboard configuration of English QWERTY text keypad segment 216 and numeric keypad segment 217 of FIG. 2 is exemplary only, and that the disclosed systems and methods may be implemented in other embodiments with information handling systems having any one or more other types of text and/or numeric keyboard segments (e.g., keyboard having German QWERTZ text keypad segment, keyboard having French AZERTY text keypad segment, keyboard having simplified Chinese text keypad segment, keyboard having Japanese text keypad segment etc.). In such embodiments, the text home position of a given keyboard is the vertical centerline between the two home bar keys of the text keypad segment. Furthermore it is not necessary that a movable keyboard have both text keypad and numeric keypad segments. Moreover, the particular configuration of touchpad, touchpad buttons, stick pointer buttons and stick pointer illustrated in FIG. 2 is exemplary only, it being understood that the presence of each of these user interface components is optional, and that other user interface components may be additionally or alternatively present.

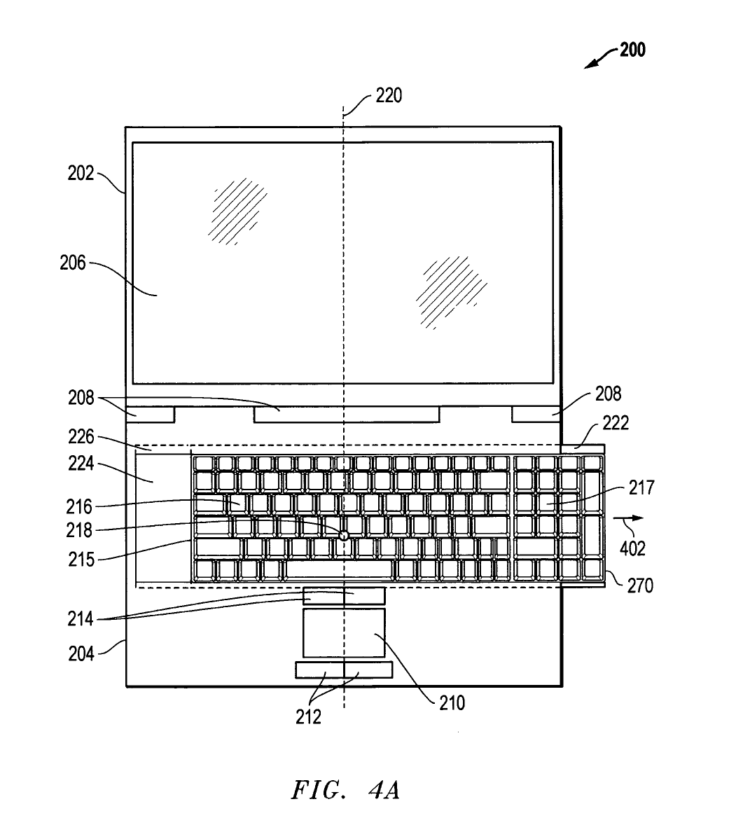

Still referring to the exemplary embodiment of FIG. 2, the vertical alignment lines (i.e., vertical centerlines in this embodiment) of touchpad 210, touchpad buttons 212, and stick pointer buttons 214 are configured to coincide with the vertical alignment line (i.e., vertical centerline 220 in this embodiment) of display 206 so that these interface devices are fixedly aligned in the vertical direction. Movable keyboard 215 of movable keyboard assembly 270 is shown slidably received within an upper channel 224 defined in the upper (palm rest-side) surface of notebook computer 200 and that is dimensioned complementary to the outer dimensions of keyboard 215 as shown. Keyboard 215 is also fixedly coupled to movable plate 222 (shown in dashed outline) of movable keyboard assembly 270 that is itself slidably received within a lower channel 226 (also shown in dashed outline) that is defined in base assembly 204 of notebook computer 200 underneath and contiguous with upper channel 224. In this exemplary embodiment, keyboard 215 is capable of moving or sliding as a single keyboard assembly within channel 224 with movable plate 222 as it slides within channel 226 in a horizontal or transverse direction rightward in relation to base assembly 204 of notebook computer 200. In this manner, movable keyboard 215 may be moved from the illustrated stowed position of FIG. 2 to a deployed position shown in FIG. 4A, as will be described further herein. In the illustrated stowed position of movable keyboard 215, the vertical alignment lines (i.e., vertical extension of text home position of movable keyboard 215 and vertical centerline of pointer stick 218) are not aligned with vertical centerline 220 of display 206 or with user interface devices 210, 212 and 214.

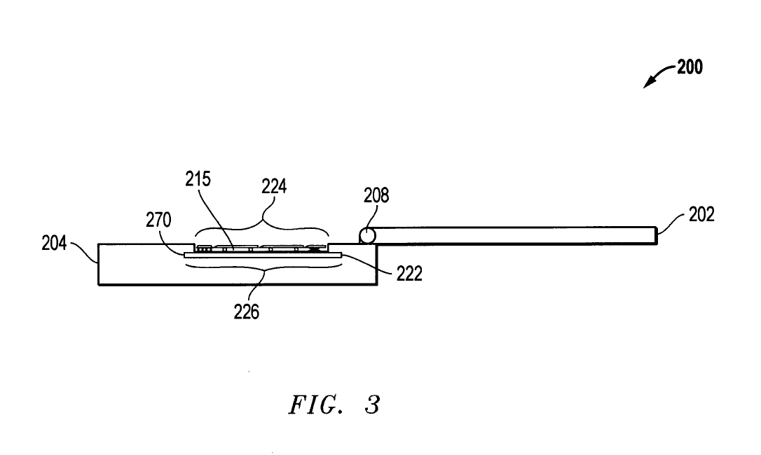

FIG. 3 illustrates a right side view of notebook computer 200 of FIG. 2, showing movable keyboard 215 received in upper channel 224 and coupled to movable plate 222 that is received within lower channel 226. As shown in FIG. 3, each of channels 224 and 226 extend fully rightward within base assembly 204 so that they each are open at the right side of base assembly 204 to allow the right ends of movable keyboard and movable plate 222 to slide together rightward so that they may be extended from the right side of base assembly 204.

FIG. 4A shows notebook computer 200 of FIGS. 2 and 3 with movable keyboard assembly 270 in deployed position so that it is extended from the right side of base portion 204 with movable plate 222 supporting the extended cantilevered portion of movable keyboard 215. In the illustrated exemplary embodiment, movable keyboard 215 may be moved within upper channel 224 with movable plate 222 as it slides within channel 226 in a horizontal or transverse direction rightward in relation to base assembly 204 of notebook computer 200 as indicated by arrow 402. As shown in FIG. 4A, text home position (i.e., the center of the “B” key of movable keyboard 215) is substantially aligned with vertical centerline 220 of display 206 when movable keyboard 215 is positioned in deployed position so that user interface devices 206, 210, 212, 214 and 215 (including 218) are substantially aligned with each other. As further shown, movable keyboard 215 (i.e., including text keypad segment 216 and numeric keypad segment 217) retains its same size and shape in the deployed position as it has in the stowed position, with the difference being the alignment of movable keyboard 215 with other user interface devices 206, 210, 212 and 214.

FIG. 4B is an exploded perspective view of the notebook computer of FIGS. 2-4A, showing movable keyboard 215 and movable plate 222 of movable keyboard assembly 270 that are positioned for slidable insertion into respective upper channel 224 and lower channel 226 of notebook computer 200 as illustrated by dashed lines.

As will be described further herein, movable keyboard assembly 270 of FIGS. 2-4 may be moved from stowed position to deployed position in any suitable manner, e.g., manually, automatically or by a combination thereof. Furthermore, one or more locking or latching mechanisms (not shown in FIGS. 2-4) may be provided for selectably retaining movable keyboard assembly 270 in stowed position (e.g., for transportation) and/or for selectably locating and retaining movable keyboard assembly 270 in deployed position to maintain substantial alignment of movable keyboard 215 with display 206 and other optional user interface devices (e.g., during use).

It will also be understood that the illustrated embodiment of movable keyboard assembly 270 (i.e., movable keyboard 215 and movable plate 222), as well as upper channel 224 and lower channel 226 of notebook computer 200 of FIGS. 2-4 is exemplary only, and that a keyboard may be movably disposed (with or without a movable plate) as part of a movable keyboard assembly in relation to a display device and/or to one or more other user interface components using any other suitable configuration. For example, in one alternate embodiment, a movable keyboard assembly may be rollably coupled in relation to the upper side of the base assembly of a portable information handling system (e.g., notebook, etc.) using cylindrical or circular roller members, or with spherical roller members such as ball bearings. Such roller members may be optionally rollably received in one or more tracks provided on the upper side of the base assembly of the portable information handling system. In another alternate embodiment, a movable keyboard assembly may be slidably coupled in relation to the base assembly of an information handling system using one or more runners that are slidably received in one or more corresponding grooves (e.g., in tongue and groove fashion). In yet another embodiment, a movable keyboard assembly may be movably coupled in relation to a display of a portable information handling system using one or more arms or other mechanisms that extend from the base assembly and/or display portion of a portable information handling system.

Furthermore, it will be understood that a movable keyboard assembly may be configured to move not only in a horizontal direction in relation to a display device and/or other user interface devices of an information handling system to more closely align or to substantially align the keyboard assembly with the display device and/or other user interface devices, but may also be configured to move in any other one or more directions (e.g., partially in a vertical direction) relative to a display device and/or other user interface devices of an information handling system. In addition, in one embodiment, a vertical alignment line of a given user interface device need not be the centerline of the given user interface device, but may be instead any vertical alignment line that is selected for the given user interface device to fit ergonomic requirements of a given application.

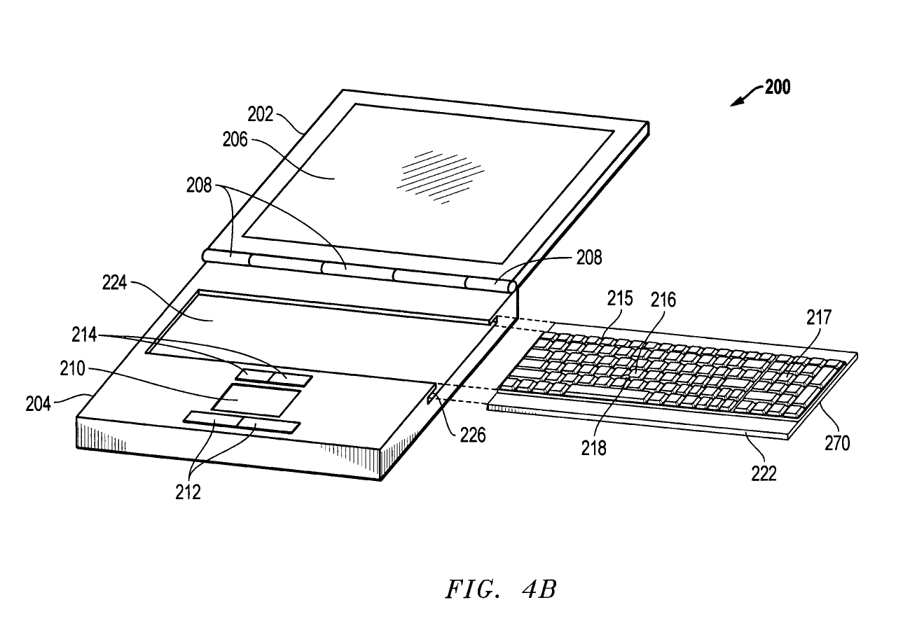

As previously described, a movable keyboard assembly may be configured to move from stowed position to deployed position in any suitable manner, e.g., manually, automatically or by a combination thereof. In this regard, FIG. 5 illustrates one exemplary embodiment of a notebook computer 200 configured with a movable keyboard assembly 270 in a manner previously described in relation to FIGS. 2-4. In the embodiment of FIG. 5, a keyboard movement mechanism is implemented using a keyboard actuator assembly in the form of an electric motor 504 and pinion 502 that is provided to move movable keyboard assembly 270 in the direction of arrow 550 between stowed and deployed position, i.e., by rotating clockwise in the direction of arrow 510.

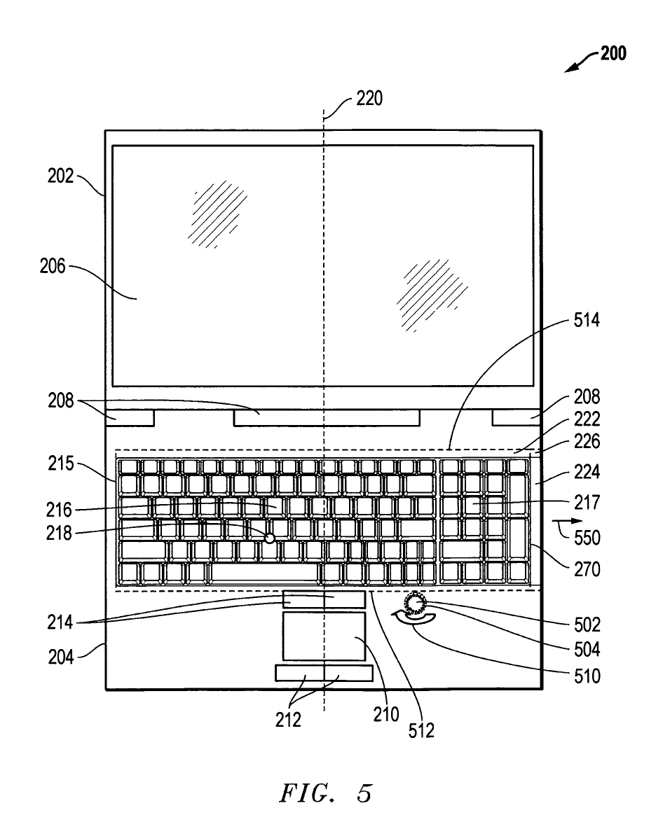

FIG. 6 shows a right side view of notebook computer 200 in which drive shaft 506 may be seen that couples motor 504 to pinion 302. In the illustrated embodiment, pinion 302 may be coupled to move movable keyboard assembly 270 by means of gear teeth configured to mate with complementary teeth of a toothed rack that is provided on the bottom edge 512 of movable plate 222 (i.e., in rack and pinion manner) so as to convert rotary motion of pinion 502 to left to right hand reciprocating motion of movable plate 222 and movable keyboard 215 of movable keyboard assembly 270.

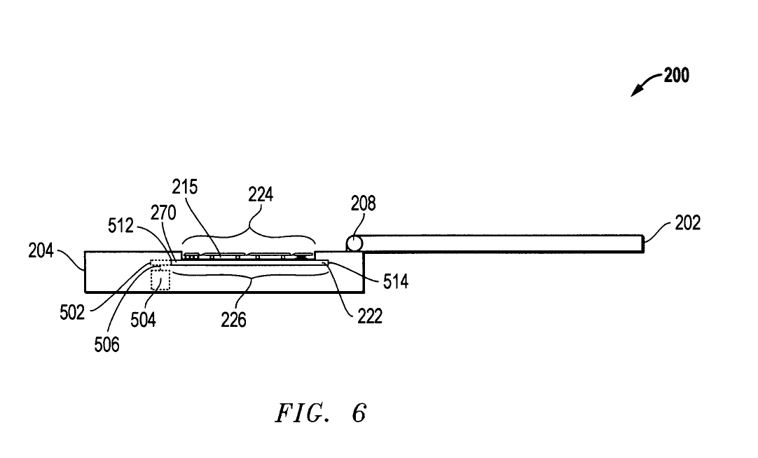

FIG. 7 shows notebook computer 200 of FIGS. 5 and 6 with movable keyboard assembly 270 in deployed position so that it is extended from the right side of base portion 204 with movable plate 222 supporting the extended cantilevered portion of movable keyboard 215 in a manner as previously described. As shown in FIG. 7, text home position (i.e., the center of the “B” key of movable keyboard 215) is substantially aligned with vertical centerline 220 of display 206 when movable keyboard assembly 270 is positioned in deployed position so that user interface devices 206, 210, 212 and 214 and 215 are substantially aligned with each other. As further illustrated in FIG. 7 electric motor 504 and pinion 502 may be configured to move movable keyboard assembly 270 from deployed position to stowed position in the direction of arrow 750, i.e., by rotating counterclockwise in the direction of arrow 511.

A motorized keyboard actuator assembly such as electric motor 504 and corresponding pinion 502 of FIGS. 5-7, may be controlled using any suitable mechanism, e.g. using a manually operated switch and/or by using a switch or other mechanism that is configured to automatically actuate movement of a movable keyboard assembly from stowed to deployed position and vice-versa. Automatic control may be achieved in some embodiments using a processor (e.g., microcontroller or microprocessor) and/or suitable discrete circuitry that acts to actuate the movable keyboard based on one or more input parameters. For example, in one exemplary embodiment a motorized keyboard actuator may be configured to be automatically controlled by the embedded microcontroller of a notebook computer based on polling the state of a lid switch that is commonly employed on most notebook computers to turn-off the LCD display of the computer and to suspend the operating system of the computer when the notebook computer lid is closed.

Referring again to the embodiment of FIGS. 5-7, a lid switch may be provided that is open when lid 202 of notebook computer 200 is opened, causing motor 504 to rotate in a clockwise direction to drive or move movable keyboard assembly 270 to the rightmost deployed position and then stop rotating (e.g., a limit switch, current-sensing switch or other suitable control device may be provided to stop rotation of motor 504 when movable keyboard assembly 270 is moved to its full rightmost position). When lid 202 is closed, the lid switch is closes and causes motor 504 to rotate in a counterclockwise direction to pull or move movable keyboard assembly 270 back into base assembly 204 of notebook computer 200, and to stop rotating when movable keyboard assembly 270 is fully seated in stowed position (once again a limit switch, current-sensing switch or other suitable control device may be provided to stop rotation of motor 504 when movable keyboard assembly 270 is moved to its full leftmost position).

It will be understood the illustrated automatic keyboard movement mechanism of FIGS. 5-7 is exemplary only, and that pinion 302 and bottom edge 512 of plate 222 may be configured with any suitable combination of complementary surfaces suitable for converting rotary motion of pinion 502 to left to right hand reciprocating motion of movable plate 222 and movable keyboard 215 of movable keyboard assembly 270. For example, pinion 502 may be provided with a relatively smooth surface (e.g., relatively smooth rubberized surface rather than gear teeth) suitable for mating with a relatively smooth-surfaced bottom edge 512 of movable plate 512 (e.g., relatively smooth plastic or metallized surface rather than toothed rack). Furthermore, it will be understood that electric motor 504 and pinion 502 may be positioned in any other location relative to keyboard 215 and plate 322 suitable for moving movable keyboard assembly 270 between stowed and deployed position, e.g., positioned adjacent the top edge 514 of plate 222, in which case a given direction of rotation of pinion 502 will achieve movement of movable keyboard assembly 270 in a direction opposite to that described above. In addition, although one keyboard actuator assembly is illustrated in FIGS. 5-7, it will be understood that more than one keyboard actuator assembly may be employed, e.g., a first actuator configured for moving movable keyboard assembly 270 from stowed to deployed position, and a second actuator configured for moving movable keyboard assembly 270 from deployed position to stowed position.

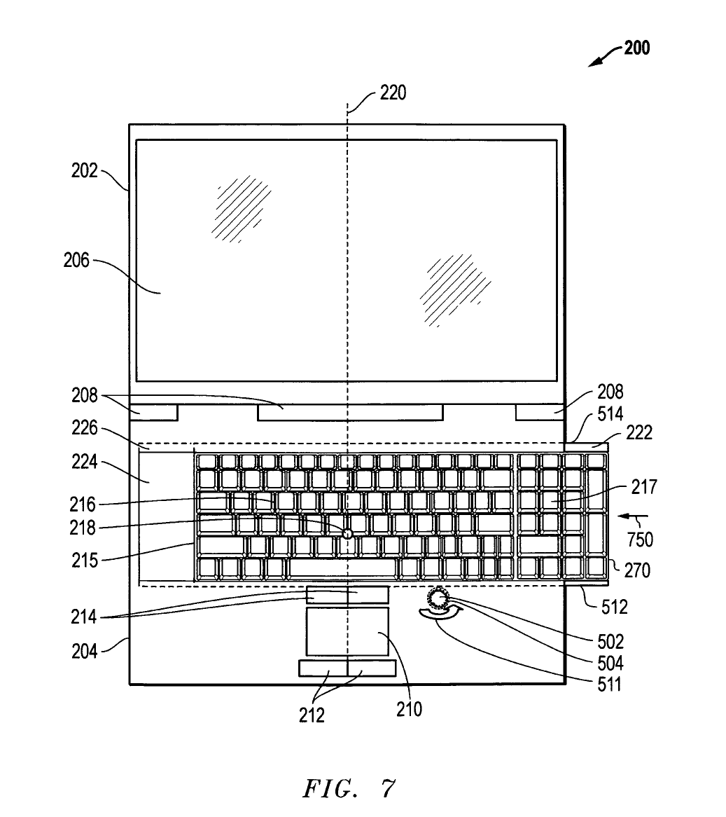

FIG. 8 illustrates another exemplary embodiment of the disclosed systems and methods in which a manually operated keyboard movement mechanism is implemented using a spring loaded latch 814 and a keyboard actuator in the form of a gas spring assembly 802 (e.g., push type form of spring and damper device) that is provided to move movable keyboard assembly 270 in the direction of arrow 850 between stowed and deployed position. In this embodiment, gas spring assembly 802 includes an actuator piston 808 that is reciprocally and slidably received in gas cylinder 806. Gas cylinder 806 is coupled to base assembly 204 of notebook computer 200 via mechanical coupling 804, and actuator piston 808 is coupled to flange 816 extending from bottom edge of movable plate 222 via mechanical coupling 810 so that gas pressure within gas cylinder 806 acts to expel actuator piston 808, and in doing so, to move movable keyboard assembly 270 in a rightward direction relative to base assembly 204.

Still referring to FIG. 8, spring loaded latch mechanism 814 is shown provided to retain movable keyboard assembly 270 in leftmost stowed position within base portion 204 by contacting right edge 820 of movable plate 222. In this stowed position, gas spring assembly 802 may be configured to be in its fully compressed position. In this embodiment, a user may manually release movable keyboard 215 and movable plate 222 of movable keyboard assembly 270 from stowed position by manually depressing latch mechanism 814 so that it no longer contacts right edge 820 of movable plate 222, allowing keyboard 215 and plate 222 of movable keyboard assembly 270 to be moved rightward to deployed position by virtue of gas pressure within gas cylinder 806 that acts to expel actuator piston 808. Thus, in this embodiment, rightward movement of movable keyboard assembly 270 is enabled and controlled by gas spring assembly 802.

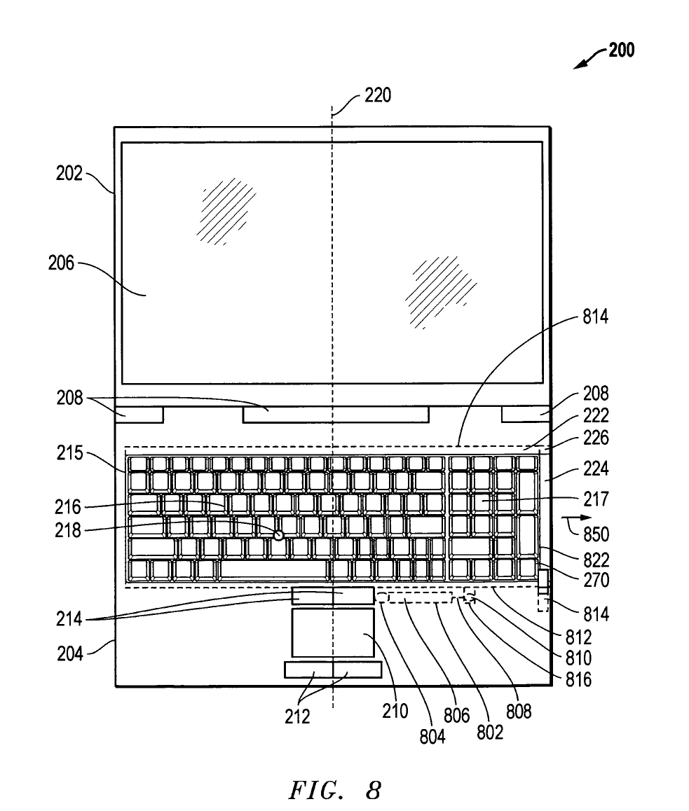

FIG. 9 shows a right side view of notebook computer 200 in which drive spring loaded latch 814 may be seen in engaged position, i.e., contacting right edge 822 of movable plate 222. Also shown is latch pivot point 815 about which latch 822 may be pivoted downward to release movable plate 222 and movable keyboard 215 of movable keyboard assembly 270 from stowed position.

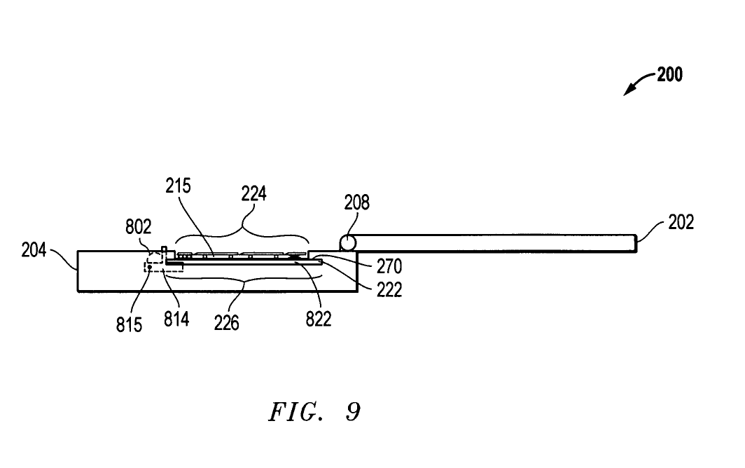

FIG. 10 shows notebook computer 200 of FIGS. 8 and 9 with movable keyboard assembly 270 in deployed position so that it is extended from the right side of base portion 204 with movable plate 222 supporting the extended cantilevered portion of movable keyboard 215 in a manner as previously described. In this deployed position, gas spring assembly 802 may be configured to be in its fully extended or uncompressed position. As shown in FIG. 10, text home position (i.e., the center of the “B” key of movable keyboard 215) is substantially aligned with vertical centerline 220 of display 206 when movable keyboard 215 is positioned in deployed position so that user interface devices 206, 210, 212 and 214 and 215 are substantially aligned with each other. As further illustrated in FIG. 10, a user may apply manual force to movable plate 222 and/or movable keyboard 215 to move movable keyboard assembly 270 from deployed position to stowed position in the direction of arrow 1050, at the same time re-compressing gas spring assembly 802 allowing spring loaded latch 814 to re-engage. In this regard, upon movement to stowed position, a spring mechanism (not shown) may be configured to provide upward force to spring loaded latch 814 about pivot point 815 so that latch 814 contacts edge 822 of movable plate 222, and so that movable plate 222 and movable keyboard 215 of movable keyboard assembly 270 are retained in stowed position within base assembly 204.

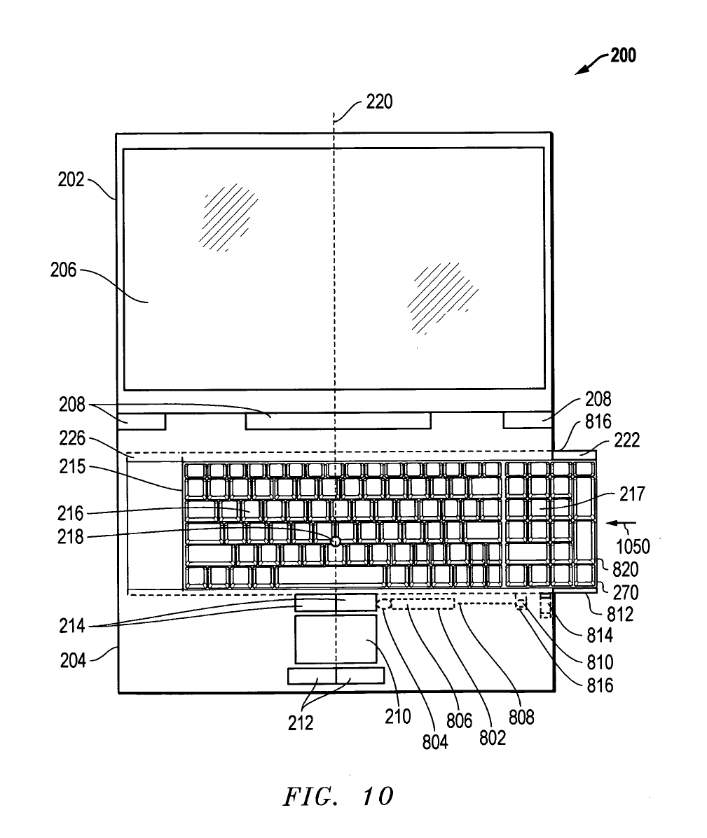

FIG. 11 shows a right side view of notebook computer 200 with movable keyboard assembly 270 in deployed position so that it is extended from the right side of base portion 204. As seen in FIG. 11, spring loaded latch 814 is depressed and pivoted below right edge 822 of movable plate 222 into disengaged position. Arrow 817 indicates the upward direction of force provided by the spring mechanism described above. Also shown is latch pivot point 815 about which latch 822 may be pivoted downward to release movable plate 222 and movable keyboard 215 of movable keyboard assembly 270 from stowed position, and pivoted upward again to retain movable plate 222 and movable keyboard 215 of movable keyboard assembly 270 in stowed position. Any other suitable latch configuration is possible, e.g., a spring-loaded sliding latch that may be slid in a first direction to release the movable plate and movable keyboard from stowed position, and that may be slid in a second direction opposite to the first direction to retain the movable plate and the movable keyboard in stowed position.

It will be understood the illustrated manual keyboard movement mechanism of FIGS. 8-11 is exemplary only, and that one or more gas spring assemblies or other suitable assemblies (e.g., non-gas operated spring assemblies) may be positioned in any suitable location or locations between base assembly 204 and movable plate 222 in order to impart sufficient force to move movable plate 222 and movable keyboard 215 of movable keyboard assembly 270 to deployed position. Furthermore, it will be understood that any other suitable configuration of one or more latch mechanisms may be employed to retain movable plate 222 and movable keyboard 215 of movable keyboard assembly 270 in stowed position. Furthermore, it is possible in other embodiments that a latch mechanism may be mechanically or electrically configured to automatically release movable plate 222 and movable keyboard 215 of movable keyboard assembly 270 from stowed position upon opening of lid 202 of notebook computer 200, and to retain movable plate 222 and movable keyboard 215 of movable keyboard assembly 270 in stowed position once lid 202 is closed and movable plate 222 and movable keyboard 215 of movable keyboard assembly 270 are manually returned to stowed position in the manner described above in relation to FIGS. 8-11. Thus, it is possible that keyboard movement mechanism may be configured to be partially automatic and partially manual in operation.

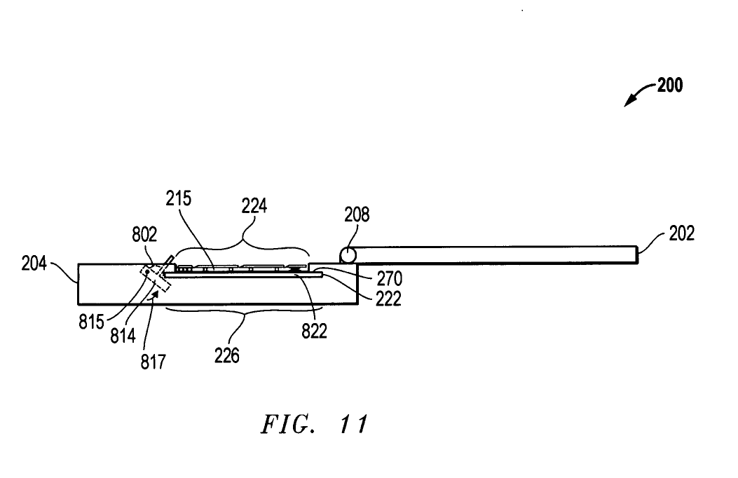

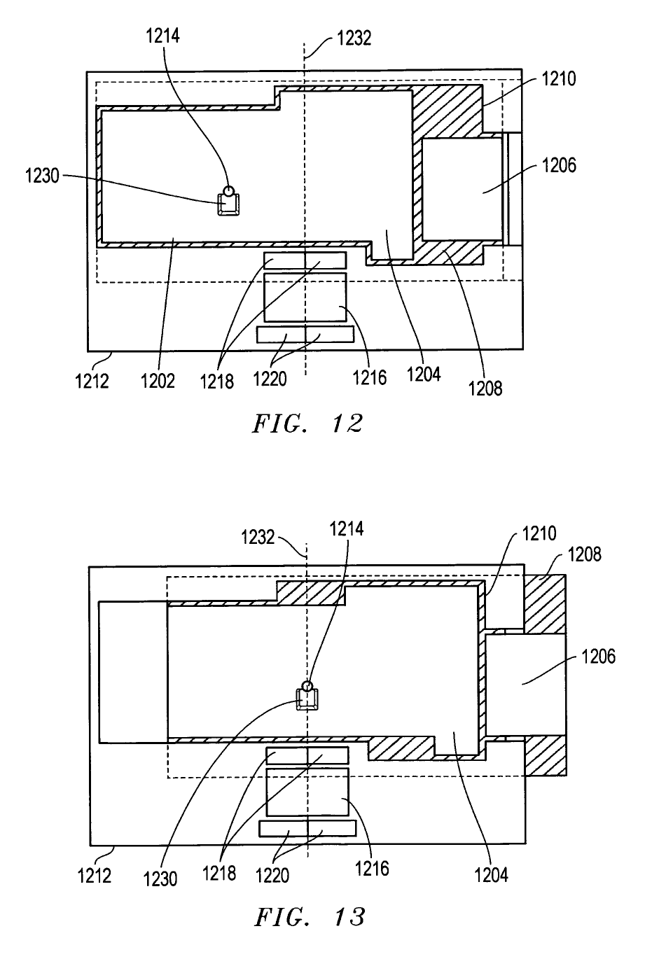

Although movable keyboard 215 has been illustrated in FIGS. 2-11 as having a rectangular outline with horizontally parallel sides, FIGS. 12 and 13 illustrate that a movable keyboard may be alternatively configured to have an irregular shape. In this regard FIG. 12 shows an irregular-shaped movable keyboard assembly 1202 slidably received in stowed position in an upper channel 1210 of a base assembly 1212 of a portable information handling system. Moveable keyboard assembly 1202 includes a movable keyboard 1203 that is fixedly coupled to a movable plate 1208 that is slidably received in a lower channel (not shown). As illustrated, movable keyboard 1203 has an irregular-shaped text keypad segment area 1204 and a numeric keypad segment area 1206. For purposes of simplicity, only key 1230 (e.g., corresponding to the B key of an English QWERTY text keypad) is shown in FIGS. 12 and 13. In this embodiment, the centerline of key 1230 corresponds to the text home position. Also shown are stick pointer 1214, touch pad 1216, stick pointer buttons 1218 and touch pad buttons 1220. Upper channel 1201 is shaped complementary to the layout of irregular-shaped keyboard segments so that movable keyboard assembly 1202 is moveable to a deployed position in a manner as previously described herein. In this regard, FIG. 13 shows moveable keyboard assembly 1202 in deployed position relative to base assembly 1212, and showing text home position (e.g., centerline of key 1230) and stick pointer 1214 aligned with the centerline 1232 of user interface devices 1220, 1216, 1218 and display device (not shown).

It will be understood that FIGS. 2-13 illustrate certain exemplary embodiments of how interface devices of an information handling system may be configured according to the disclosed systems and methods. In this regard, the disclosed systems and methods may be implemented with both portable and non-portable information handling systems to position a keyboard relative to other user interface devices of the information handling system, e.g., in any application in which a base assembly or other mounting assembly for the keyboard is disposed (e.g., fixedly disposed) relative to a display device so that the keyboard itself benefits from adjustment relative to the display device to improve ergonomic alignment or reduce the lateral distance between the home position of the keyboard and the vertical centerline of the display device. Furthermore, it will be understood that it is not necessary that a keyboard include both text keypad and numeric keypad segments, nor that a portable information handling system include touchpad, touchpad button, stick pointer and/or stick pointer button components. Rather, the disclosed systems and methods may be implemented with a variety of other configurations of information handling systems and/or keyboards that are configured to provide input from a user to an information handling system.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communications between the various hardware components.

While the invention may be adaptable to various modifications and alternative forms, specific embodiments have been shown by way of example and described herein. However, it should be understood that the invention is not intended to be limited to the particular forms disclosed. Rather, the invention is to cover all modifications, equivalents, and alternatives falling within the spirit and scope of the invention as defined by the appended claims. Moreover, the different aspects of the disclosed systems and methods may be utilized in various combinations and/or independently. Thus the invention is not limited to only those combinations shown herein, but rather may include other combinations.

What is claimed is:

1. An information handling system, comprising:
a base assembly;
a first user interface device fixedly coupled in a horizontal direction to said base assembly; and
a movable keyboard assembly movably coupled to said base assembly so that said movable keyboard assembly is selectably movable in said horizontal direction between a first position relative to said first user interface device and a second position relative to said first user interface device;
wherein said movable keyboard is more closely vertically aligned with said first user interface device when said movable keyboard assembly is disposed in said second position than when disposed in said first position.

2. The information handling system of claim 1, wherein said information handling system comprises a portable information handling system.

3. The information handling system of claim 2, wherein said movable keyboard assembly comprises a keyboard having a text keypad segment, said text keypad segment having a text home position; and wherein an alignment line of said first user interface device is substantially vertically aligned with said text home position of said text keypad segment when said movable keyboard assembly is disposed in said second position.

4. The information handling system of claim 3, wherein said keyboard of said movable keyboard assembly further comprises a numeric keypad segment fixedly disposed in rightward adjacent relationship to said text keypad segment.

5. The information handling system of claim 2, wherein said first user interface device comprises a display device of said portable information handling system, said display device having a vertical centerline; wherein said movable keyboard assembly comprises a keyboard having a text keypad segment, said text keypad segment having a text home position; and wherein said vertical centerline of said display device is substantially aligned with said text home position of said text keypad segment when said movable keyboard assembly is disposed in said second position.

6. The information handling system of claim 2, further comprising a keyboard actuator assembly coupled to said movable keyboard assembly, said keyboard actuator mechanism being configured to move said movable keyboard assembly from said first position to said second position, from said second position to said first position, or a combination thereof.

7. A notebook computer, comprising:
a base assembly;
a display device having a centerline and being coupled to said base assembly by one or more hinge mechanisms so that said display device is hingeably movable between an open position and a closed position relative to said base assembly; and
a movable keyboard assembly movably coupled to said base assembly so that said movable keyboard assembly is selectably movable in a horizontal direction between a first stowed position relative to said display device and a second deployed position relative to said display device;
wherein said movable keyboard assembly comprises a movable keyboard having a text keypad segment, said text keypad segment having a text home position; and
wherein said text home position of said text keypad segment is more closely vertically aligned with said centerline of said display device when said movable keyboard assembly is disposed in said second position than when disposed in said first position.

8. The notebook computer of claim 7, wherein said movable keyboard of said movable keyboard assembly further comprises a numeric keypad segment fixedly disposed in rightward adjacent relationship to said text keypad segment.

9. The notebook computer of claim 8, wherein said movable keyboard of said movable keyboard assembly has the same size and shape in the second deployed position of said movable keyboard assembly as in the first stowed position of said movable keyboard assembly; wherein said text home position of said text keypad segment is not vertically aligned with said centerline of said display device when said movable keyboard assembly is disposed in said first stowed position; and wherein said text home position of said text keypad segment is substantially vertically aligned with said centerline of said display device when said movable keyboard assembly is disposed in said second deployed position.

10. The notebook computer of claim 9, further comprising a touchpad fixedly disposed on a palmrest area of said base assembly, said touchpad having a centerline that is substantially aligned with said centerline of said display device so that said text home position of said text keypad segment is substantially vertically aligned with said centerline of said touchpad when said movable keyboard assembly is disposed in said second deployed position.

11. The notebook computer of claim 9, wherein said movable keyboard assembly is a single piece keyboard assembly; wherein the outer dimensions of said movable keyboard assembly are horizontally and vertically contained within the outer dimensions of said base assembly when said movable keyboard assembly is disposed in said first position;
and wherein a right side portion of said movable keyboard assembly extends outside the right horizontal boundary of said base assembly when said movable keyboard assembly is disposed in said second position.

12. The notebook computer of claim 7, further comprising a keyboard actuator assembly coupled to said movable keyboard assembly, said keyboard actuator mechanism being configured to move said movable keyboard assembly from said first stowed position to said second deployed position, from said second position to said first stowed position, or a combination thereof.

13. The notebook computer of claim 12, wherein said keyboard actuator is configured to automatically move said movable keyboard assembly to said second deployed position when said display device is opened; and wherein said keyboard actuator is configured to automatically move said movable keyboard assembly to said first stowed position when said display device is closed.

14. The notebook computer of claim 7, wherein said keyboard assembly is retained and slidably received in at least one horizontal channel defined in a palmrest surface of said base assembly that is open at a right side of said base assembly; and wherein a right side portion of said movable keyboard assembly extends outside the right horizontal boundary of said base assembly through said open horizontal channel when said movable keyboard assembly is disposed in said second position.

15. A method for configuring an information handling system, comprising:
providing a first user interface device coupled to a base assembly so that said first user interface device is horizontally fixed in position relative to said base assembly; and
movably coupling a movable keyboard assembly to said base assembly so that said movable keyboard assembly is selectably and horizontally movable between a first position relative to said first user interface device and a second position relative to said first user interface device;
wherein said movable keyboard is more closely vertically aligned with said first user interface device when said movable keyboard assembly is disposed in said second position than when disposed in said first position.

16. The method of claim 15, wherein said information handling system comprises a portable information handling system; wherein said first user interface comprises a display device having a centerline; and wherein said display device is coupled to said base assembly by one or more hinge mechanisms so that said display device is hingeably movable between an open position and a closed position relative to said base assembly.

17. The method of claim 16, wherein said movable keyboard assembly comprises a movable keyboard having a text keypad segment, said text keypad segment having a text home position; and wherein said text home position of said text keypad segment is substantially vertically aligned with said centerline of said display device when said movable keyboard assembly is disposed in said second position than when disposed in said first position.

18. The method of claim 17, wherein said movable keyboard of said movable keyboard assembly further comprises a numeric keypad segment fixedly disposed in rightward adjacent relationship to said text keypad segment; and wherein said base assembly comprises a touchpad fixedly disposed on a palmrest area of said base assembly, said touchpad having a centerline that is substantially aligned with said centerline of said display device so that said text home position of said text keypad segment is substantially vertically aligned with said centerline of said touchpad when said movable keyboard assembly is disposed in said second position.

19. The method of claim 15, wherein said movable keyboard assembly is a single piece keyboard assembly; wherein the outer dimensions of said movable keyboard assembly are horizontally and vertically contained within the outer dimensions of said base assembly when said movable keyboard assembly is disposed in said first position; and wherein a right side portion of said movable keyboard assembly extends outside the right horizontal boundary of said base assembly when said movable keyboard assembly is disposed in said second position.

20. The method of claim 15, further comprising coupling a keyboard actuator assembly to said movable keyboard assembly, said keyboard actuator mechanism being configured to move said movable keyboard assembly from said first position to said second position, from said second position to said first position, or a combination thereof.
